(19) United States
(12) Patent Application Publication
(10) Pub. No.: US 2009/0015721 A1
(43) Pub. Date: Jan. 15, 2009

(54) METHODS AND APPARATUS USING SHARED STORAGE FOR CANNEL ERROR CORRECTION AND MULTIMEDIA DECODING AND PROCESSING IN A DIGITAL TV SYSTEM

(75) Inventors: YANBIN YU, FREMONT, CA (US); RONZHANG HU, FREMONT, CA (US); LIN YANG, (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/775,204

(22) Filed: Jul. 9, 2007

(51) Int. Cl. H04N 5/44

(52) U.S. Cl. 348/725

(57) ABSTRACT

An OFDM receiver is provided that comprises a channel decoder; a source decoder; and a memory controller coupled to the channel decoder and source decoder to control the channel decoder, the source decoder and a memory separate from the apparatus such that the memory is shared by both the channel decoder and the source decoder.

### FIELD OF THE INVENTION

The present invention relates generally to memory sharing, more specifically the present invention relates to methods and apparatus using shared storage for cannel error correction and multimedia decoding and processing in a digital TV System.

### BACKGROUND

In modern digital communication and broadcast systems, channel decoders are used in advanced channel error correction schemes such as convolution code, LDPC codes, turbo code, FEC codes, and others rely on the interleaving storage mechanism to counter the effects of burst error and eliminate the correlations between the neighboring bits. Thereby, the advanced communication channel performance can be greatly improved. The performance results vary, but sometimes can be extremely close to the Shannon Limit.

Typically, the storage implementations make use of separate storage devices to minimize the bandwidth requirement. Some known implementations make use of the internal SRAM module in order to save or reduce the connections to outside a chip. Such implementations are sensible if the de-interleaving memory does not need to be big. However, if the de-interleaving memory is reasonably big or significantly bigger for an internal memory, internal SRAM may not be a good option. The reason is that since big memory using generic digital process is not optimal in real estate of the silicon implementation. Such big memory is necessarily forced to move into somewhere outside the chip physically for cost and power considerations.

On the other hand, source decoding in multimedia processing such as video and audio decoding and pre-processing and post-processing need significantly bigger memory space for temporal storage which typically should be realized using outside storage devices. If the associated storage of the channel decoder and the source decoder accessed and controlled separately, the memory controllers for each device may be somewhat simplified, but the cost for the two separate memories is high and power consumption is high as well.

Therefore, it is desirable and sensible to combine the de-interleaving memory and multimedia processing memory as one.

### SUMMARY OF THE INVENTION

A method and device for to combine the de-interleaving memory and multimedia processing memory as one are provided.

A digital receiver having a method and device for to combine the de-interleaving memory and multimedia processing memory as one is provided.

A digital video receiver having a method and device for to combine the de-interleaving memory and multimedia processing memory as one is provided.

An apparatus is provided that comprises a channel decoder; a source decoder; and a memory controller coupled to the channel decoder and source decoder to control the channel decoder, the source decoder and a memory separate from the apparatus such that the memory is shared by both the channel decoder and the source decoder. A method of making the same apparatus is provided therefore.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1. is an example a receiver in accordance with some embodiments of the invention.

FIG. 2 is an example in accordance with some embodiments of the invention.

FIG. 3 is an example of a flowchart in accordance with some embodiments of the invention.

FIG. 4 is an example of a time slot assignment of data in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to combine the de-interleaving memory and multimedia processing memory as one. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions to combine the de-interleaving memory and multimedia processing memory as one. The non-processor circuits may include, but are not limited to, a radio receiver, a radio transmitter, signal drivers, clock circuits, power source circuits, and user input devices. As such, these functions may be interpreted as steps of a method to combine the de-interleaving memory and multimedia processing memory as one. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

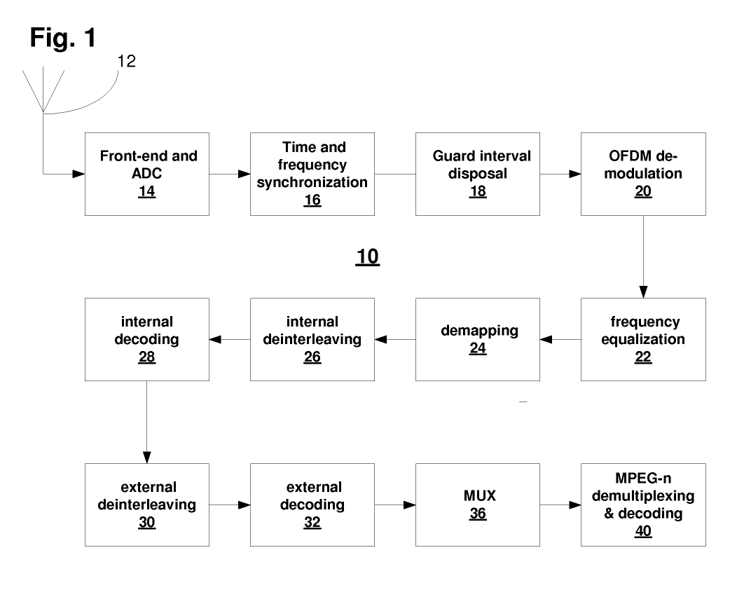

Referring to FIGS. 1-4, depictions of the present invention are shown. In FIG. 1, the block diagram of a typical OFDM receiver 10 is shown. Analog RF signal is received wirelessly via antenna 12 and fed into Front-end and ADC 14, wherein the analog RF signal is converted to base-band and transformed into a digital signal, using an analog-to-digital converter (ADC). In turn, the transformed digital signal is then subject to time and frequency synchronization 16, wherein the digital base band signal is searched to identify the beginning of frames and blocks. Eventual problems on the frequency of the components of the signal are corrected herein as well. Within the synchronization block 16, the guard interval at the end of the previous symbol is placed at the beginning in order to find the beginning of a new or next OFDM symbol. On the other hand, continual pilots (whose value and position is determined in the standard and thus known by the receiver) are used to determine the frequency offset suffered by the signal. Alternatively, known PN sequences, used as guard intervals are used to determine the frequency offset suffered by the signal. This frequency offset might have been caused by Doppler Effect, inaccuracies in the transmitter or receiver clock, etc. Guard interval disposal: the cyclic prefix may be removed 18. The OFDM symbols are demodulated 20. Frequency equalization: the pilot signals or any known sequence may be used to equalize the received signal 22. Demapping 24 may be performed. Internal deinterleaving 26 is done. Internal decoding: that may use the Viterbi algorithm is done 28. External deinterleaving may be performed 30. External decoding may be done 32. MUX adaptation including dividing digital signals into various channels is done 34. MPEG-2 demultiplexing and source decoding is, in turn, performed 36.

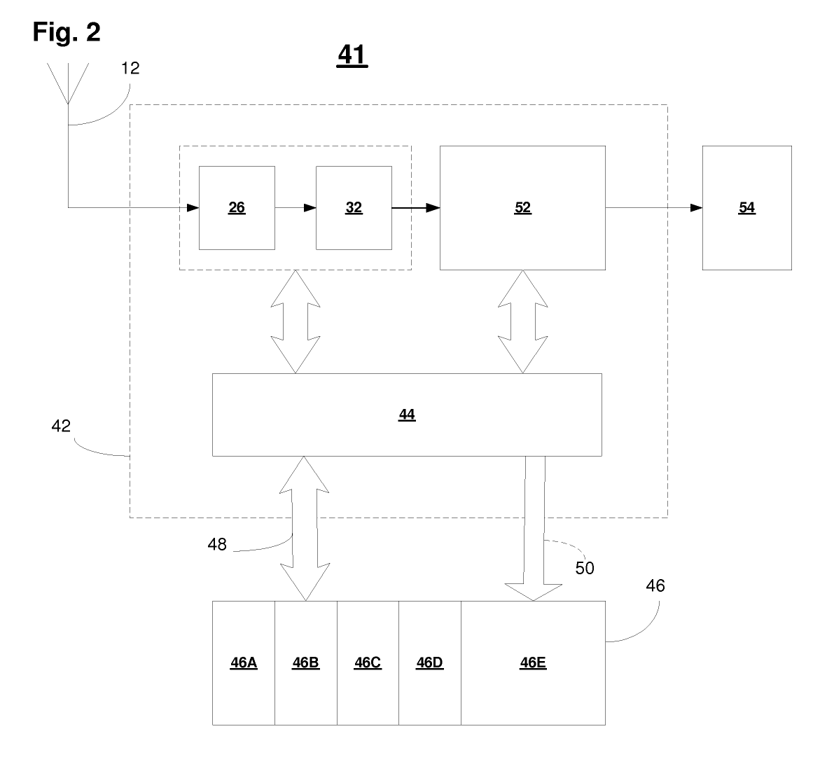

In FIG. 2, a simplified and detailed depiction 41 of the present invention is shown. A combined block 26/30 combining the function and structure of blocks 26 and 30 received information coupled to antenna 12. Combined block 26/30 processes information relating to internal and external de-interleaving respectively. Combined block 26/30 are bidirectionally coupled to a memory controller 44, which in turn is coupled to a bidirectional data bus 48 and address bus 50. Bidirectional data bus 48 bidirectionally couples Memory controller 44 with a single, shared memory 46. Address bus 50 unidirectionally couples Memory controller 44 with a single, shared memory 46. Single, shared memory 46 is a storage system comprising sup-storage space for varies things. They are internal and external de-interleaving space 46A, 46B, video decoding space 46C, audio decoding space 46D, and space 46E for other purposes.

A source decoder 52 processing information relating to video and audio decoding receives information coupled to block 26/30 and outputs processed information to an output device 54 such as a display screen or a speaker. Similarly, source decoder 52 is bidirectionally coupled to a memory controller 44, which in turn is coupled to bidirectional data bus 48 and address bus 50. Bidirectional data bus 48 bidirectionally couples Memory controller 44 with single, shared memory 46. Address bus 50 unidirectionally couples Memory controller 44 with single, shared memory 46. Single, shared memory 46 is storage system comprising sup-storage space for varies things. They are internal and external de-interleaving space 46A, 46B, video decoding space 46C, audio decoding space 46D, and space 46E for other purposes.

In the preferred embodiment, a single silicon chip 42 with channel decoding functions and structures 26/30 as well as source multimedia decoding functions and structures 52 with a single shared storage system 46 such as Static random access memory (SRAM), dynamic Random Access Memory (DRAM), synchronous DRAM (SDRAM), double data rate type of memories including DDR, DDR-II,III, etc. The outside storage system 46 has two major functions: they are error correction 26/30 and source decoding 52. The storage module 46 is accessed in a time division multiplexing fashion by channel error decoding module and by multi-media decoding module 52 as well. By doing so, the cost of the whole communication system is significantly reduced. The de-interleaving is part of the function of error correction operations. The memory used by this module is part of shared memory with shared input and output data bus with video and audio decoders. The present invention contemplates a digital TV system having both channel decoding and source decoding functions using the same separated, outside chip RAM such as SDRAM, SDRAM, DDR SDRAM, DR-2, DDR-3 SDRAM storage for both de-interleaving 26/30 and multi-media decoding 52. The said apparatus and systems to perform both channel encoding and source encoding.

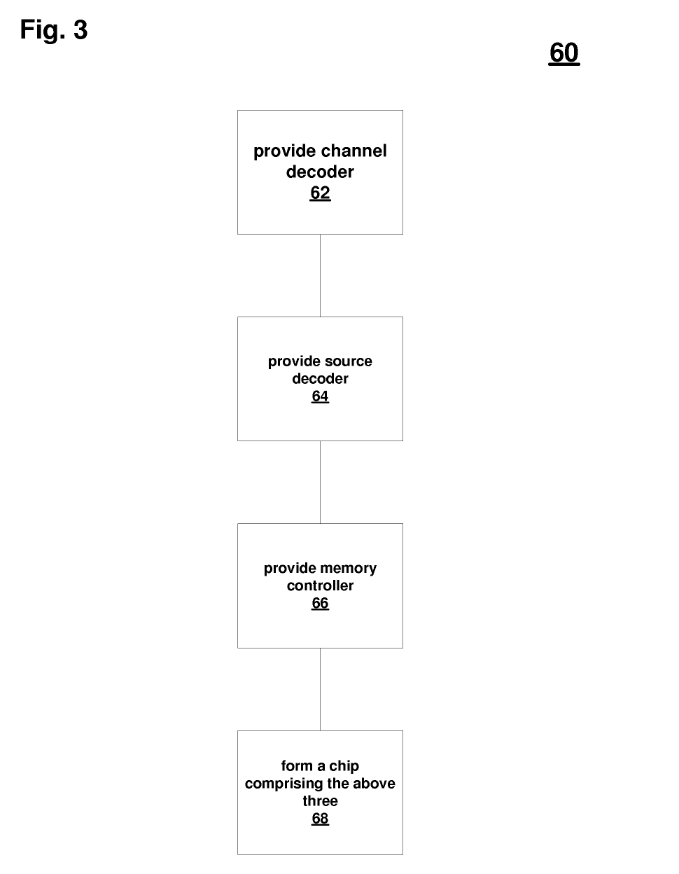

Referring to FIG. 3, a flowchart 60 of the present invention is shown. Flowchart 60 depicts a method for making a device of the present invention comprising the step of providing a channel decoder (Step 62). Providing a source decoder (Step 64). Providing a memory controller coupled to the channel decoder and source decoder to control the channel decoder, the source decoder and a memory separate from the apparatus such that the memory is shared by both the channel decoder and the source decoder (Step 66). Form the channel decoder, the source decoder, and memory controller in a single integrated circuit (IC) chip (Step 68). However, the memory is separate from the apparatus.

With the development of the DRAM technology such as SDRAM's DDR1 and DDR2, the memory capacity, as well as access bandwidth are greatly improved and power consumption per mega-bits is significantly reduced.

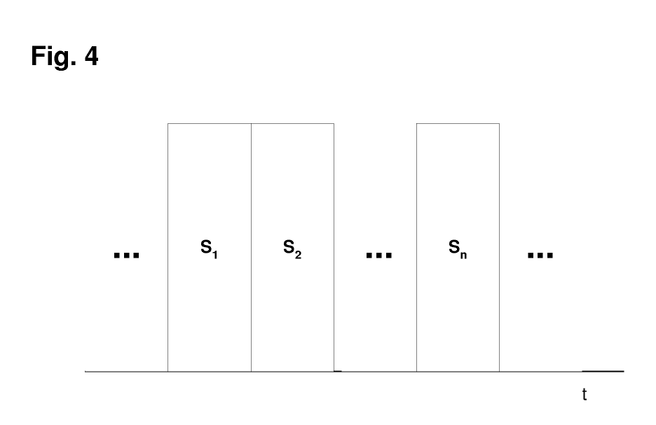

Referring to FIG. 4, a scheme for tme slot assignment of data 46 is shown. slot S1 may contain data that correspond to a specific type of data 46 such as audio decoding data 46D or other suitable data 46. In turn, slot S2 may contain data that correspond to a specific type of data 46 other than slot S1, etc until Sn is reached. Form S₁-Sₙ, a cyclic or period achieved where the rest of the relevant time line repeats the content or data type of S₁-Sₙ. Alternatively, other predetermined arrangements or distributions for arranging data in memory 46 are contemplated.

The present invention is suitable for any DTV system that uses or requires a significantly large memory 46 for processing. An exemplified DTV system is the time division synchronized-orthogonal frequency division multiplex (TDS-OFDM) system. U.S. patent application Ser. No. 11/677,225, to Zhong, entitled “TIME DE-INTERLEAVER IMPLEMENTATION USING SDRAM IN A TDS-OFDM RECEIVER” describes such a system, which is hereby incorporated herein by reference.

The present invention contemplates applications in a TDS-OFDM system or receiver. U.S. patent application entitled “Receiver Structure for an LDPC-Based TDS-OFDM Communication System” Ser. No. 11/740,712, filed Apr. 26, 2007, Attorney Docket No. LSC-P016 is hereby incorporated herein by reference.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. An apparatus comprising:
a channel decoder;
a source decoder; and
a memory controller coupled to the channel decoder and source decoder to control the channel decoder, the source decoder and a memory separate from the apparatus such that the memory is shared by both the channel decoder and the source decoder.

2. The apparatus of claim 1, wherein the memory comprises Static random access memory (SRAM), dynamic Random Access Memory (DRAM), synchronous DRAM (SDRAM), or double data rate type of memories including DDR, DDR-II, III.

3. The apparatus of claim 1, wherein the apparatus is a digital television receiver.

4. The apparatus of claim 1, wherein the apparatus is an orthogonal frequency division multiplexing (OFDM) digital television receiver.

5. A method comprising the step of:
providing a channel decoder;
providing a source decoder; and
providing a memory controller coupled to the channel decoder and source decoder to control the channel decoder, the source decoder and a memory separate from the apparatus such that the memory is shared by both the channel decoder and the source decoder.

6. The apparatus of claim 5, wherein the memory comprises Static random access memory (SRAM), dynamic Random Access Memory (DRAM), synchronous DRAM (SDRAM), or double data rate type of memories including DDR, DDR-II, III.

7. The apparatus of claim 5, wherein the apparatus is a digital television receiver.

8. The apparatus of claim 5, wherein the apparatus is an orthogonal frequency division multiplexing (OFDM) digital television receiver.
